(19) United States
(12) Patent Application Publication
(10) Pub. No.: US 2006/0016952 A1
(43) Pub. Date: Jan. 26, 2006

(54) Support apparatus and methods for one or more items

(75) Inventor: Jonathan P. Workman, Loveland, CO (US)

Correspondence Address: SANTANGELO LAW OFFICES, P.C., 125 SOUTH HOWES, THIRD FLOOR, FORT COLLINS, CO, 80521, US

(73) Assignee: Ultimate Support Systems, Inc., Fort Collins, CO (US)

(21) Appl. No.: 10/896,458

(22) Filed: Jul. 21, 2004

(51) Int. Cl. G10G 5/00

(52) U.S. Cl. 248/443

(57) ABSTRACT

Inventive musical instrument support apparatus and methods relative to independently inventive aspects of support technology. One aspect of the inventive technology may be directed to a collapsible musical instrument stand such as a guitar stand that includes a support element that exhibits an enhanced low profile in a retracted mode. Another aspect of the invention may focus on provision of the capability of simultaneous deployment and retraction of an assembly of multiple musical instrument supports upon reconfiguration of only one of the supports. Inventive musical instrument support stands may include either or both of the individually inventive aspects.

### BACKGROUND OF THE INVENTION

Generally, this inventive technology relates to advancements in item support apparatus and methods, including but not limited to guitar stands. Specifically, one aspect of the inventive technology relates to provision of a capability to achieve an enhanced low profile when all or a certain part of a retractable item support apparatus is reconfigured from a deployed, support mode to a retraction mode. Another aspect relates to the enablement of simultaneous reconfiguration of a plurality of support elements from a retraction mode to a support mode upon manipulation of only one of the support elements.

The desire to provide and use stands or generally, item support apparatus to support an item or items (such as musical instruments) has been known for many years. In a basic form the concept involves design of a structure that in some manner contacts an item and supports it off of the underlying surface. Typically the item supported (e.g., a guitar) is unable to free-stand and, for certain reasons related to economy of space, aesthetics, safety, item longevity, etc., it may be undesirable to store the item laying flat on its side in a non-standing position. Thus, items such as guitars and perhaps tools (particularly those that are substantially longitudinal) are particularly suited for support by a structural stand.

However, although such stands have been known for awhile, there are certain aspects thereof that can be improved. For example, many stands are collapsible from their deployed, support mode to a retracted mode for reasons related to ease of transport and economy of space. However, designers of such known, collapsible stands have not focused particularly on reducing the space occupied by the stand in its retracted mode, and such reduced space is an attractive feature to, e.g., musicians who have a limited amount of space in which to store and transport their gear and instruments as they travel to their next venue.

Another opportunity for improvement applies to those stands that are able to support more than one item at one time (e.g., a multiple guitar stand). In such stands, there is typically at least one set of a plurality of support elements (e.g., an upper set of supports that each can carry a guitar by its headstock). In prior art stands with such multiple item support capability, in order to reconfigure all the support elements of one set from a retracted mode to a deployed, support mode (or vice versa) it is necessary to reconfigure each support element individually. Such a design presents one more task that a user or the crew needs to attend to and contributes to the time necessary to set up and breakdown equipment.

As to both the musical instrument support industry and the overall desire to support items, aspects of the present inventive technology disclose techniques which overcome virtually every one of the previous problems or inconveniences in a practical fashion. Perhaps surprisingly, the inventive technology satisfies a long-felt need to enhance the efficiency of gear and equipment setup and breakdown, in addition to addressing economy of space concerns related to stands in their retracted mode (e.g., in their collapsed, transport configuration).

### SUMMARY OF THE INVENTION

The present invention includes a variety of aspects which may be selected in different combinations based on the particular application or needs to be addressed. One aspect of the inventive technology may be directed to an item support apparatus (a guitar support stand, or a tool support stand, as but two examples) that includes a support element that exhibits an enhanced low profile in a retracted (e.g., storage or transport) configuration. Another aspect of the invention is directed towards the provision of the capability of simultaneous deployment and retraction of an assembly of multiple item supports (e.g., at least two item supports) upon reconfiguration of only one of the supports. Each of these aspects may be combined in one multiple item support stand, whether they are found together in one set of supports (e.g., an upper set of support elements), or whether one set of supports has one capability and another the other capability.

A key application of the present invention is, indeed, the musical instrument support industry, and in particular, guitar stands (including both singular and multiple guitar stands). However, many different types of item or items (particularly those that have a major, longitudinal axis) may be supported by support apparatus (and by support methods) that are not so limited.

It may be an object of the “simultaneous deployment” aspect of the inventive technology to expedite the set-up and breakdown of the support element.

It may be an object of the “enhanced low profile” aspect of the inventive technology to better utilize existing space available for storage and transport of support apparatus. Additional objects may be to reduce costs related to storage bags for collapsed support apparatus by reducing material needs thereof, and to effect a more aesthetic streamlined profile of the apparatus in its retracted mode. Naturally, further objects of the invention are disclosed throughout other areas of the specification and claims.

### BRIEF DESCRIPTION OF THE DRAWINGS

FIG. 1 shows a closeup of backrests of an embodiment of a two guitar stand when the backrests are in a retracted mode. These two support elements have the enhanced low profile capability in retracted mode.

FIG. 2 shows a closeup of backrests of an embodiment of a three guitar stand when the backrests are in a retracted mode. These three support elements have the enhanced low profile capability in retracted mode.

FIG. 3 shows a closeup of backrests of an embodiment of a two guitar stand when the backrests are in a deployed, support mode. These two support elements have the enhanced low profile capability in retracted mode.

FIG. 4 shows a closeup of backrests of an embodiment of a three guitar stand when the backrests are in a deployed, support mode. These three support elements have the enhanced low profile capability in retracted mode.

FIG. 5 shows a closeup of upper, item support elements of an embodiment of a two guitar stand when the support elements are in a retracted mode. These two support elements have simultaneous deployment capability.

FIG. 6 shows a closeup of upper, item support elements of an embodiment of a three guitar stand when the support elements are in a retracted mode. These three support elements have simultaneous deployment capability.

FIG. 7 shows a closeup of upper, item support elements of an embodiment of a two guitar stand when the support elements are in a deployed, support mode. These two support elements have simultaneous deployment capability.

FIG. 8 shows a closeup of upper, item support elements of an embodiment of a three guitar stand when the support elements are in a deployed, support mode. These three support elements have simultaneous deployment capability.

FIG. 9 shows an embodiment of a two guitar stand in retracted mode. The upper, item support elements have simultaneous deployment capability while the lower, item support elements have enhanced low profile capability in a retracted mode.

FIG. 10 shows an embodiment of a three guitar stand in retracted mode. The upper, item support elements have simultaneous deployment capability while the lower, item support elements have enhanced low profile capability in a retracted mode.

FIG. 11 shows an embodiment of a two guitar stand in deployed, support mode. The upper, item support elements have simultaneous deployment capability while the lower, item support elements have enhanced low profile capability in a retracted mode.

FIG. 12 shows an embodiment of a three guitar stand in deployed, support mode. The upper, item support elements have simultaneous deployment capability while the lower, item support elements have enhanced low profile capability in a retracted mode.

FIG. 13 shows a closeup, cut-away, plan view of backrests (a type of support element) of an embodiment of a single guitar stand having enhanced low profile capability in retracted mode. The figure shows the backrests in their deployed, support mode. The bias element in this embodiment is a horizontally situated leaf spring.

FIG. 14 shows a closeup, cut-away, side (and slightly perspective) view of backrests of an embodiment of a single guitar stand having enhanced low profile capability in retracted mode. The figure shows the backrests in their deployed, support mode. The bias element in this embodiment is a vertically situated leaf spring.

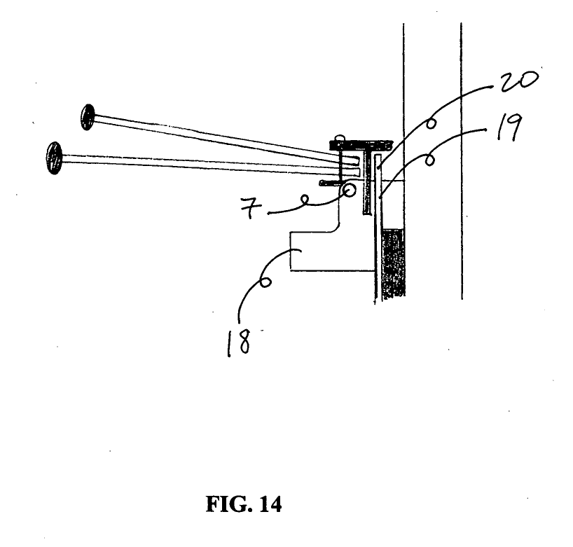

FIG. 15 shows a closeup, cut-away, perspective view (from above) of a horizontally disposed leaf spring forming the bias element for a support element of an embodiment of the a single item support apparatus having a support element with enhanced low profile capability in retracted mode. The figure shows part of the backrests in their deployed, support mode. Each support element member has a leaf spring.

### DETAILED DESCRIPTION OF THE PREFERRED EMBODIMENTS

As mentioned earlier, the present invention includes a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, and applications. Further, this description should further be understood to support and encompass descriptions and claims of all the various embodiments, systems, techniques, methods, devices, and applications with any number of the disclosed elements, with each element alone, and also with any and all various permutations and combinations of all elements in this or any subsequent application.

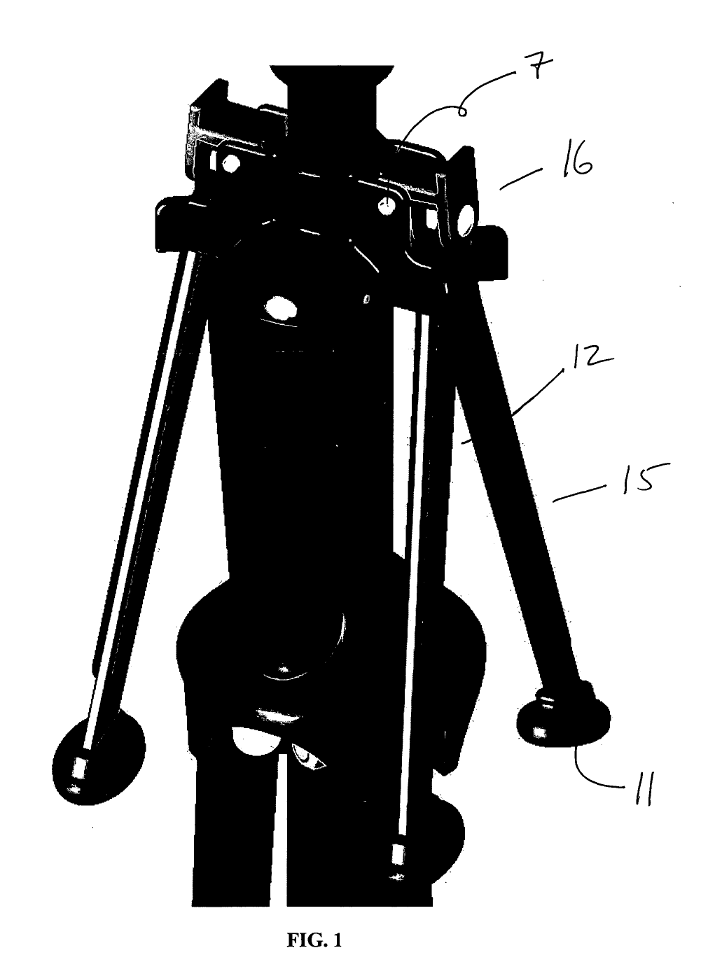

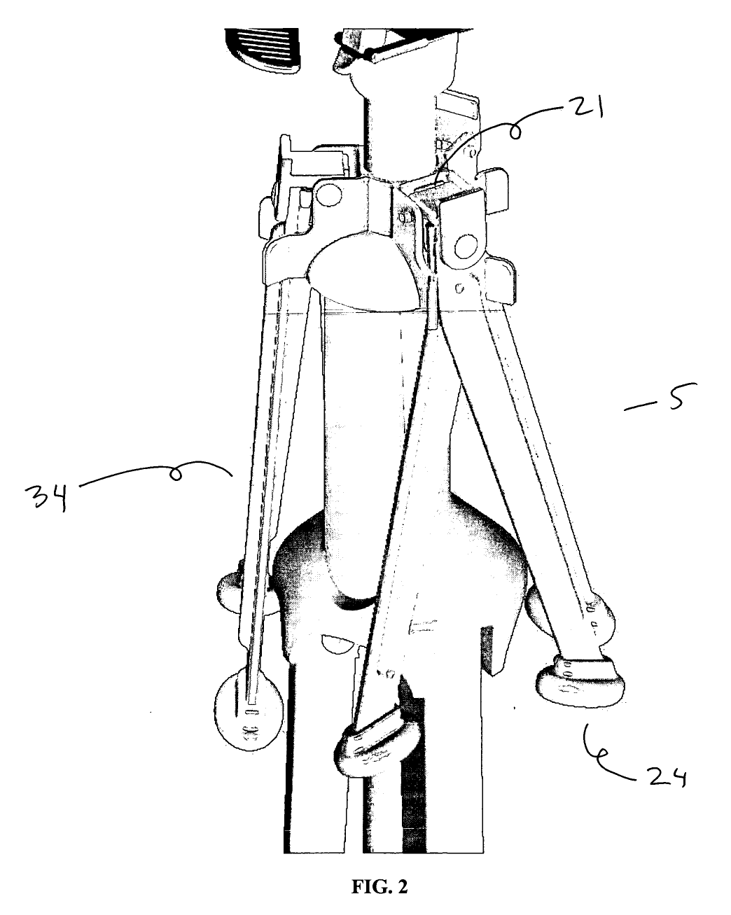

One aspect of the inventive technology may be directed to an item support apparatus (a musical instrument support apparatus (1)—including a guitar support stand (2)—or a tool support stand, as but two examples) that includes a support element that exhibits an enhanced low profile in a retracted (e.g., storage or transport) configuration (3). Such enhanced, low profile configuration (see, e.g., FIGS. 1 and 2) may have advantages during, e.g., storage or transport, such as a reduction in the amount of required storage space as compared with prior art stands of the same size, in addition to reducing the chance that the retracted apparatus will hit or snag obstructions, thereby lessening annoyance and the potential of injury to the support apparatus or the obstruction. As should be understood, profile may refer to the outline defined by support element features when viewed, e.g., from the side. A support element (4) may exhibit an enhanced, low profile (5) if its profile is “lower” (or less projecting) than profiles of prior art support elements.

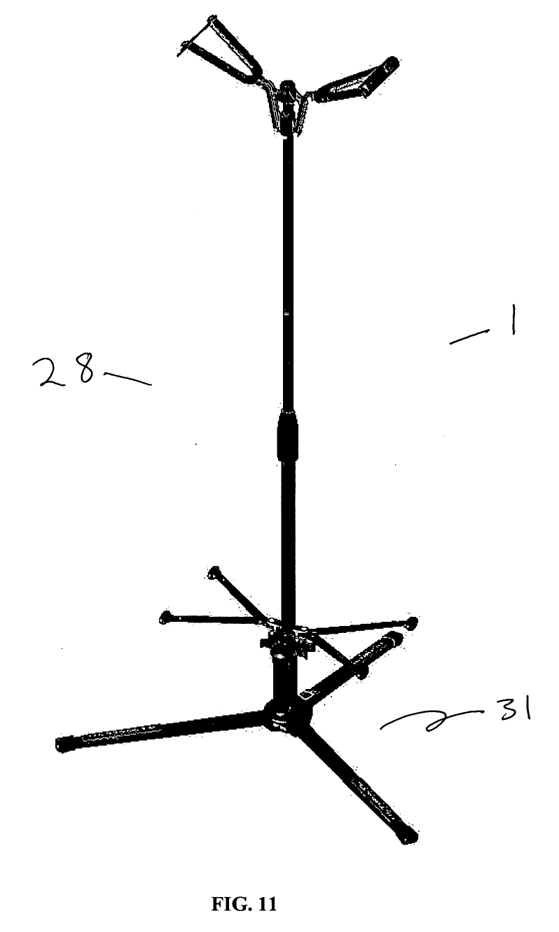

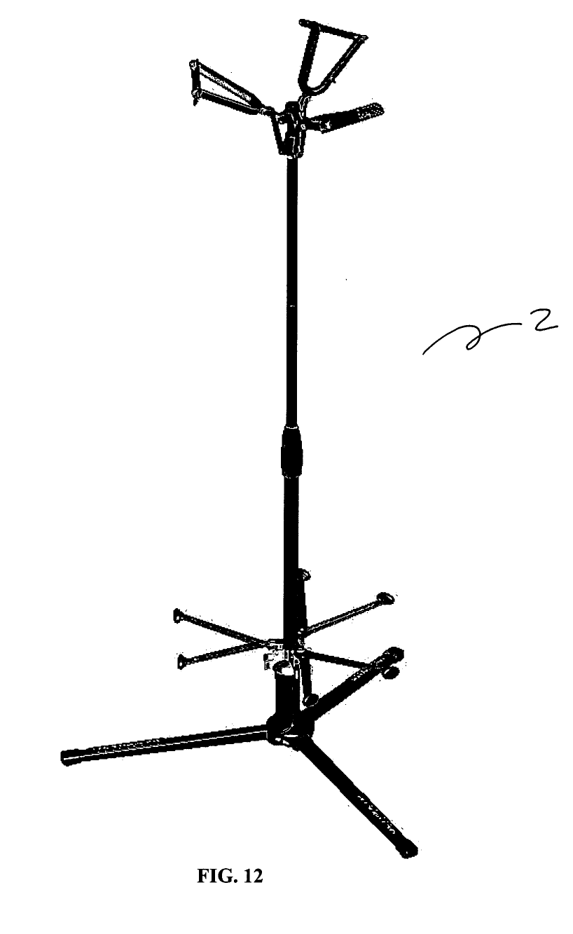

It should be understood that the support element that has the enhanced low profile capability will typically be only a part of a larger support apparatus, which itself will have other parts or structures that may be referred to as support elements (see, e.g., FIGS. 11 and 12). For instance, particularly relative to apparatus able to support more than one item, the apparatus may also have a central support element (6) (e.g., a substantially vertical, central support element or member, which may or may not be “central” or height adjustable) that, when the apparatus is reconfigured to a retracted or storage configuration, may assume a central, inner position relative to the support element(s) having enhanced low profile capability. The support element(s) having enhanced low profile capability may be established at any position along another support element (e.g., a central support element) that may exist as part of the apparatus. If it is established (e.g., connected with and pivotally movable relative to the central stem, whether about a fixed point (7) or not) at or near the top of such ‘other’ support, the support elements having enhanced low profile capability may be particularly suited to serve as an upper support element (e.g., an upper, item carrier element such as a yoke (8)). Thus, an upper support element(s) (9) (e.g., upper, item carrier element(s) such as a yoke(s) for supporting a guitar by its headstock) may also be adapted to have enhanced low profile capability. If it (or they) is established at a lower point on another support element (again, e.g., a central support element), it (or they) may be particularly suited to serve as an backrest (10) or other type of stop for the item supported.

It should also be noted that not only may any upper support elements that exist be height adjustable, but also any lower support element(s) (e.g., a lower backrest(s)) may be height adjustable, whether individually or together.

Although it is not required that an element, structure or member of the apparatus contact the item to be supported in order to be a support element, a support element having enhanced low profile capability in a preferred embodiment does contact the supported item (i.e., it is adapted to contact the item), regardless of where relative to another support element it (or they) may be established. Such contact may occur at a pod (11) (e.g., a small rubber or plastic “cushion”) established at an end of each of the support element members (which may be referred to as second support element members), said end being distal of the other support element (e.g., a first support element that may be a central support element) when the support element members are in a deployed, support mode.

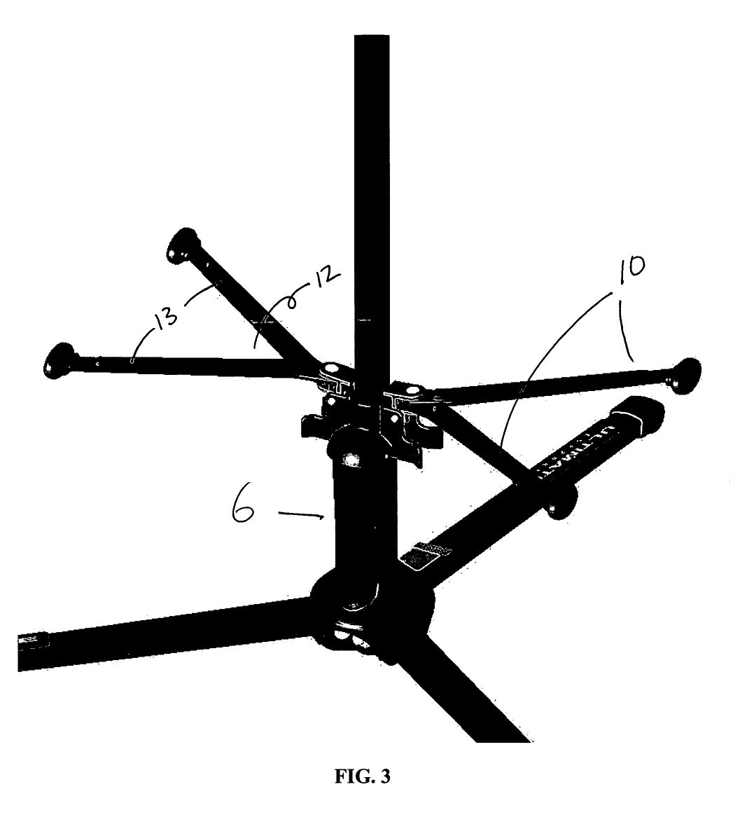

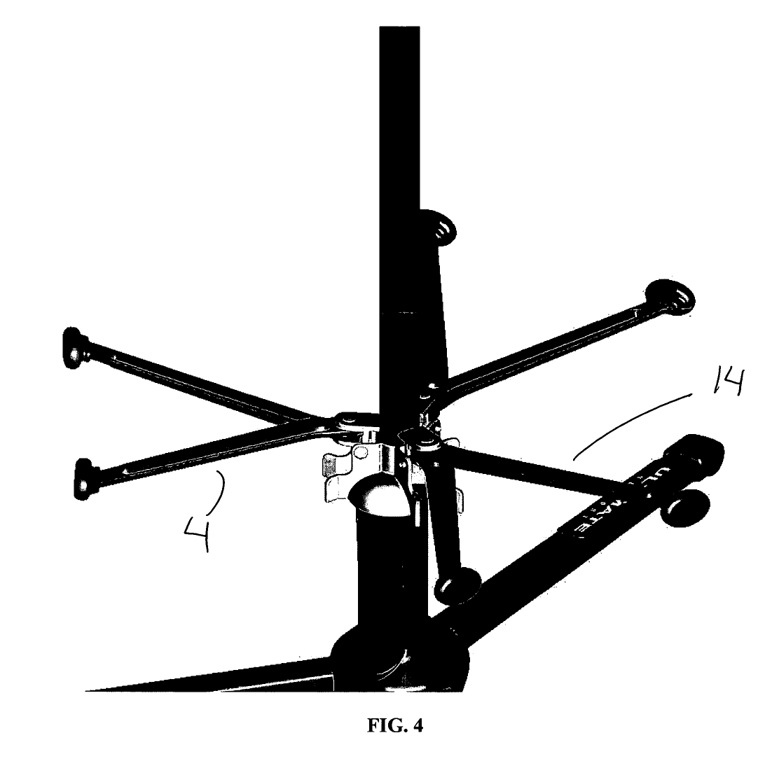

The enhanced, low profile aspect of the inventive technology may be noticed when the support element having the enhanced low profile capability is reconfigured from a deployed, support mode (see, e.g., FIGS. 3 and 4) to a retracted mode (see, e.g., FIGS. 1 and 2) and compared with the profile exhibited by support elements of prior art item support apparatus of similar size in their retracted configuration. During such reconfiguration of the inventive apparatus, a reduction in the angle defined by two support element members (13) (perhaps forming a “V” (12) in retracted and deployed modes) of the support element having the enhanced low profile capability will be recognizable (although perhaps only to the discerning observer); this angle reduction—and the relative motion of the support element members that effects it—will result in a more “streamlined” and lower profile in retracted mode than that exhibited by prior art stands. Indeed, in one embodiment, the distance between the ends of that portion of each of the two support members that is distal another support element such as a central support element that may exist is greater when these support members are in their deployed, support configuration (or mode) (14) than when they are in their retracted mode (15). Further, in certain embodiments the support element (e.g., a second support element) is established substantially against another support element (e.g., a first support element such as any central support element that may exist) when the support element is in its retracted mode (see, e.g., FIGS. 1 and 2). It should be noted that in at least one embodiment of the inventive technology, in order to reconfigure a support element having enhanced low profile capability from a deployed, support mode to a retracted mode, the support element may require that it be rotatably folded (e.g., manually downward).

In a preferred embodiment, the angle (i.e., that angle defined by two support element members of the support element having the enhanced low profile capability) will be increased during reconfiguration of the support from storage mode to deployed, support mode by that amount by which the angle is decreased during reconfiguration from deployed, support mode to storage mode. In at least one embodiment of the invention, it is an angle change element (16) that enables the angle change between the two modes (e.g. from a first angle defined by two support element members in their deployed, support mode to a second angle defined by two support element members in their retracted mode) and does so, preferably, automatically upon such reconfiguration. In varying embodiments of the invention, the second angle may be greater than 10% less, greater than 15% less, greater than 20% less, or greater than 25% less said first angle (or it may assume other relative values). It should be noted that where there are more than two support element members, the “outer” two members (e.g., those defining the greatest angle) are deemed to define the angle referred to. Further, it is important to note that whenever the straight line distance between ends of support members (that are distal of a support element such as a central support element) is reduced during reconfiguration from a deployed, support mode to a retracted mode, an angle change element has caused this reduction.

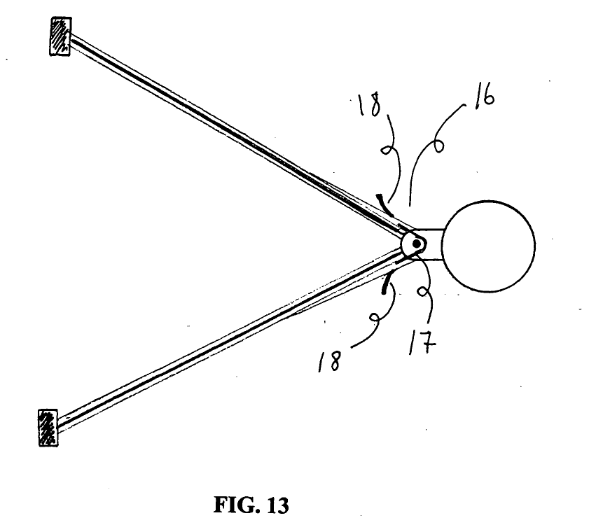

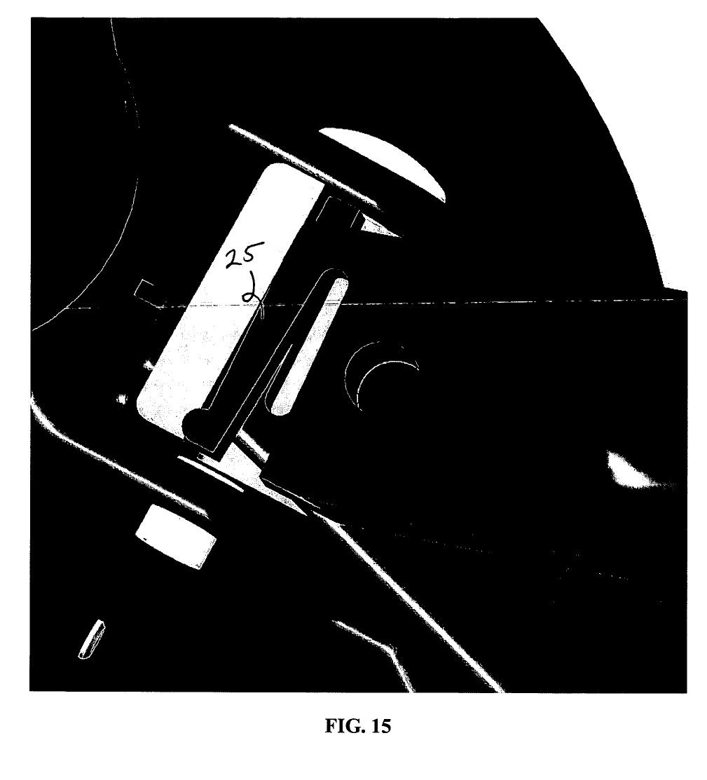

In at least one embodiment, the angle change element comprises a bias element (17) (e.g., a leaf spring as in, e.g., FIG. 15, or a coil spring, as in, e.g., FIG. 13) as but two examples). The bias element may bias two support members (by biasing one or both of them) in their relative position (including angle) observed when the support element is in a deployed, support position. The bias element may work in conjunction with a guide element (18) that forces one or more of the support members of the support element having the enhanced low profile capability to define a reduced angle (as compared with that observable in deployed, support mode) when the support members are reconfigured to a storage mode.

The enhanced, low profile embodiment of the inventive technology may also comprise a deployed, support mode lock element (19) that locks the two support elements in the deployed, support mode. In one embodiment of the invention, such lock element may comprise a biasing leaf spring lock (20).

It is important to understand that any device or mechanism that keeps (or merely assists in keeping) the indicated structure(s) in a deployed mode when that structure(s) is subjected to an expected design load or force during item support is deemed a deployed, support mode lock element (21). It need not (although it may) achieve an indexed, “click” position. Although it may take many forms, two preferred forms include an outwardly biased button lock (22) that engages to lock mode when a collar (23) no longer obstructs its biased motion (this lock type seems particularly suited to embodiments of the simultaneously deployable aspect of the invention discussed below) and a biasing leaf spring lock (this lock type seems particularly suited to embodiments of the enhanced low profile capability aspect of the invention). Many types of locks, including those involving unidirectionally engaging teeth, and locks that operate according to the principle of friction, as but a few examples, are deemed within the scope of lock element.

It should also be understood that the item support apparatus may be particularly adapted to support any of several different items, including but not limited to a musical instrument support apparatus (e.g., a guitar support apparatus, more conventionally known as a guitar stand) and a tool support apparatus. The term guitar support apparatus includes not only guitar stands that can support only one guitar at a time, but also multiple guitar stands that can support more than one guitar at a time).

The support element having the enhanced low profile capability may be any of the support elements that is reconfigurable between a deployed, support mode to a storage mode, including but not limited to an upper support element such as an upper, item carrier element (e.g., an upper, musical instrument carrier element such as an upper, guitar carrier element for supporting a guitar by its headstock as in FIG. 12 (as but one example of several such figures). In may also or instead be an item stop (24) such as a backrest that is adapted to contact a portion of an item (e.g., a back side of a supported guitar). In serving in such capacity, such support element may prevent the supported item from contacting a different support element (e.g., a central support member) when such support element is in its deployed, support mode (see, e.g., FIGS. 3 and 11). In designs where acting as a stop, the deployed support element members might not effect appreciable vertical support of the supported item; such support may be provided by other support elements. The term support element is intended to encompass a broad range of structural elements that include not only those supports that directly contact the item supported, but also those that do not contact the item supported but still bear some or all of the weight of the item or items supported (e.g., a central support element).

The item support apparatus that includes a support element that exhibits an enhanced low profile in a retracted configuration may also comprise a base support element (25) (e.g., a tripod) that serves to provide additional stability to the apparatus during operation. Such base may be reconfigurable into a retracted mode from a deployed, support mode, and may also comprise a deployed, support mode lock.

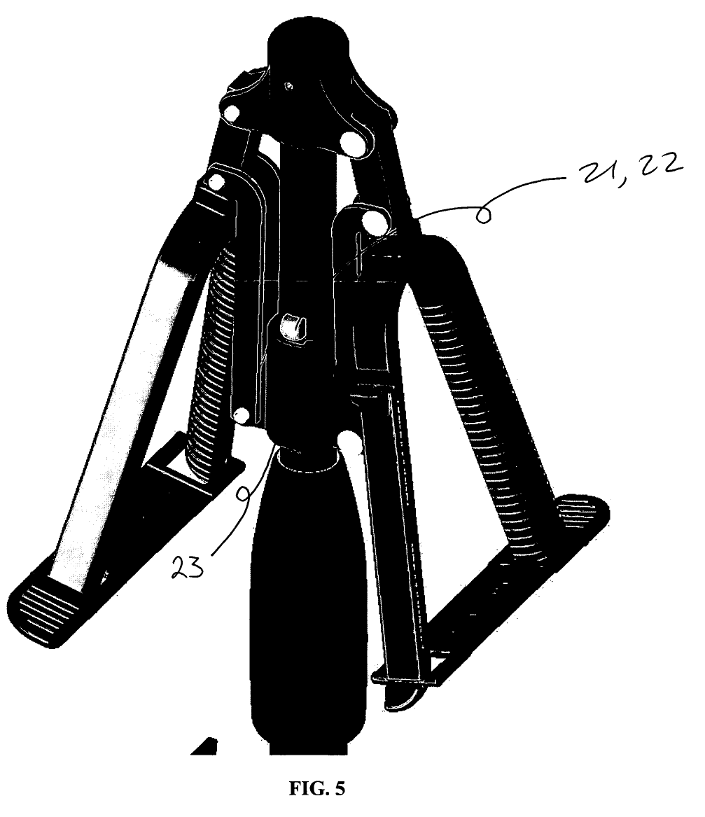

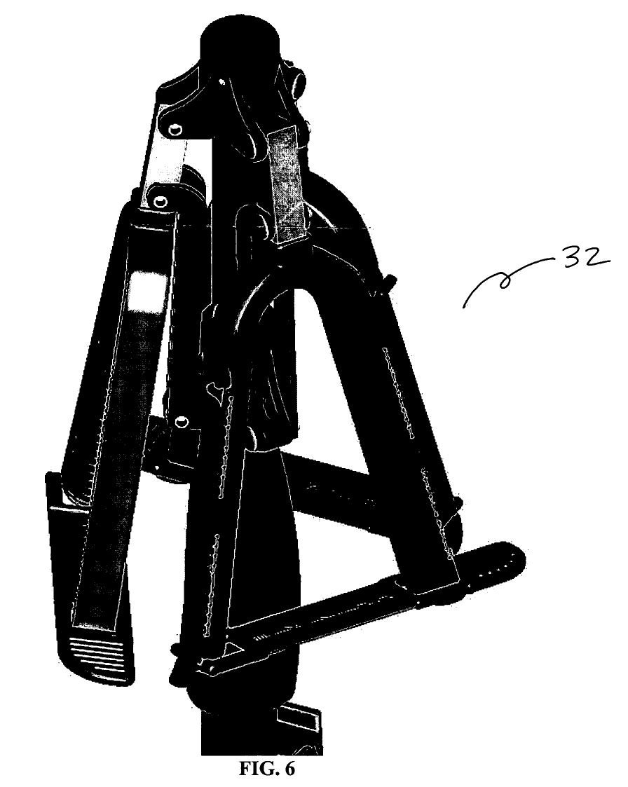

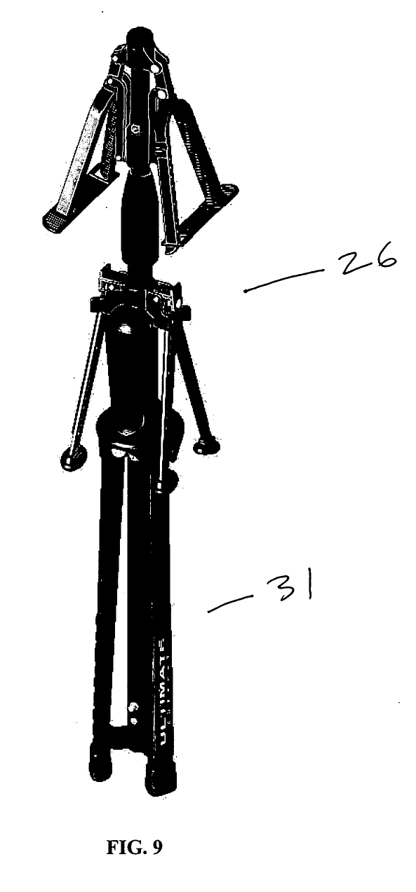

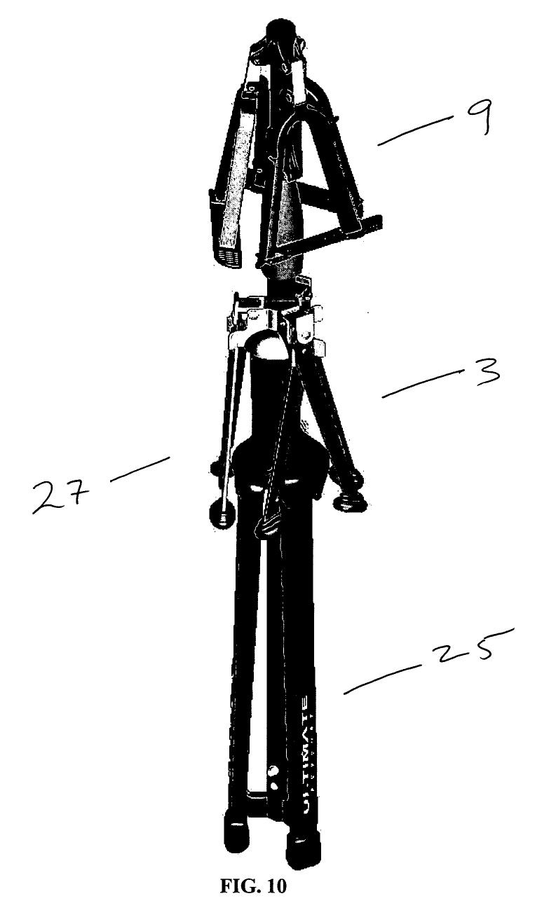

Another aspect of the invention is directed towards the provision of the capability of simultaneous deployment and retraction of an assembly of multiple item supports (e.g., at least two item supports) upon reconfiguration of only one of the supports. Such a feature (for purposes of simplicity, such feature may be referred to as “simultaneous deployment”) may be found in a multiple item support apparatus (26) (a multiple musical instrument support apparatus (27)—including a multiple guitar stand (28)—or a multiple tool stand, as but two examples). Certain embodiments of apparatus having such feature (see, e.g., FIGS. 5-12) include advantages relative to ease and speed of setup and breakdown of the apparatus.

Such a multiple item support apparatus may include a substantially vertical, central support element (29); at least two support elements connected with the substantially vertical, central support element (e.g., a substantially vertical, central support member), and each adapted to support a musical instrument; a base (31) with which the substantially vertical, central support element is connected, where all of the support elements are simultaneously reconfigurable from a retracted mode (32) to a deployed, support mode (33) upon reconfiguration of only one (and perhaps any one) of the support elements. The apparatus may further include a deployed, support mode lock element that locks the at least two support elements in their deployed, support mode.

It is important to understand that this feature may be incorporated in any part of a multiple item support stand where there is some type of support element provided for each item to be supported and where such support element is reconfigurable between a deployed, support mode and a storage mode. Although in preferred embodiments, upper support elements (e.g., upper, item carriers) are typically the support elements that provide such simultaneous deployment, certainly other support elements (e.g., lower item stops such as item backrests) can be adapted to have such capability.

It should also be understood that in a multiple item support stand (or even a singular item support stand, for that matter), any of the support elements that are reconfigurable between a deployed support mode and a storage mode may provide the above-described enhanced low profile feature when in retracted mode. Thus, although a preferred application of the enhanced low profile capability is item stops (e.g., back rests), any support element(s) that is reconfigurable between a deployed, support mode and a storage mode may be adapted to exhibit the enhanced low profile capability.

One multiple item support apparatus (e.g., a multiple guitar stand) may have sets of item contacting support elements (34) (one set may be, e.g., a set of two or more upper, guitar support elements, while another set may be a set of guitar stops or guitar backrests), each of which may have either the enhanced low profile capability or the simultaneous deployment capability, or both. However, at least one set that has either or both capabilities. Where there are sets of item contacting support elements (of course, such elements contact the item supported), and particularly where one set is above another, each support element of one set may correspond with a support element of the other set to support an item (e.g., a guitar). Such correspondence may of course be achieved merely by establishing a support element of an upper set of support elements directly above the lower support element with which it corresponds (e.g., so it has the same “longitude” relative to a central support element as is shown in FIGS. 11 and 12).

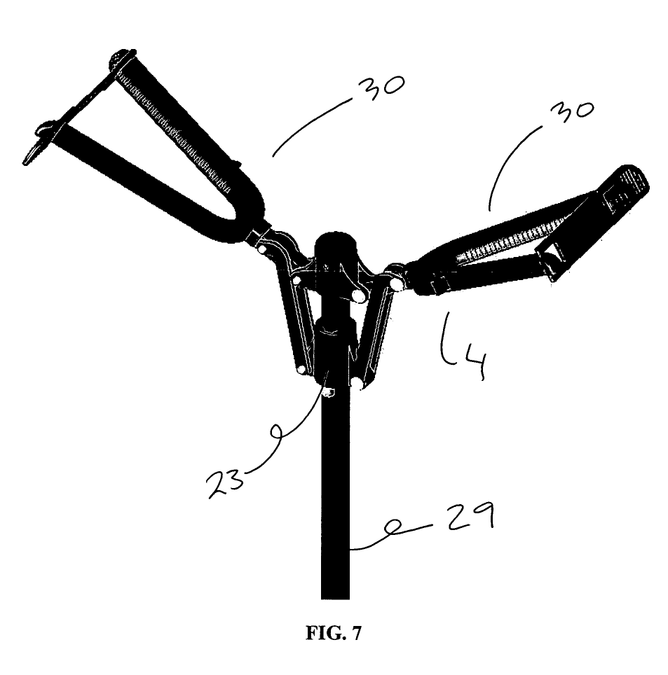

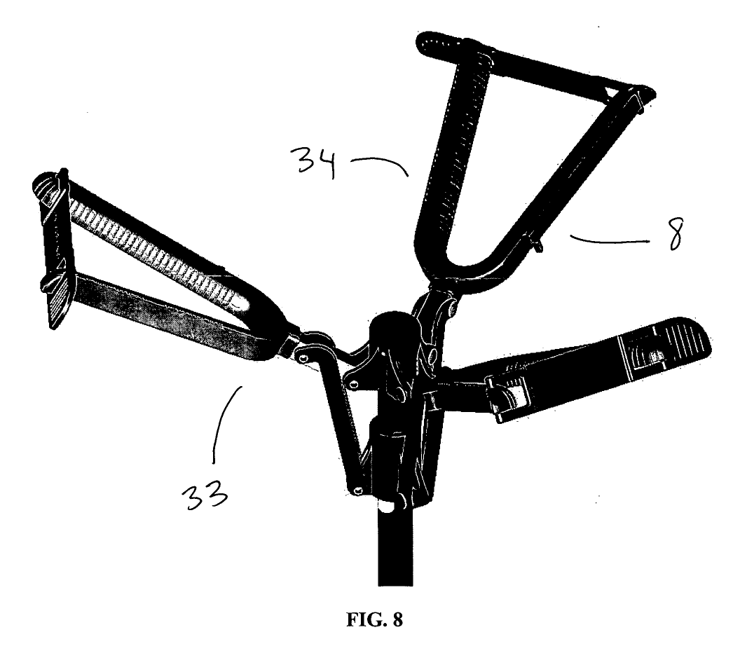

The deployed, storage mode lock element used in the simultaneous deployment aspect of the inventive technology—an element which may also find application in support element(s) affording the enhanced low profile aspect of the inventive technology—may automatically activate when the support elements are reconfigured to their deployed, support mode (see, e.g., FIGS. 7 and 8). As mentioned, this lock element may take many forms (indeed it may be the same type of lock as found in any lock that may exist on other support elements of the apparatus) but in certain embodiments it is either an outwardly biased button lock, or a biasing leaf spring lock (25).

Reconfiguration of the support elements having simultaneous deployment capability between a deployed, support mode and a storage mode may be manual reconfiguration, including one-handed reconfiguration. In order to reconfigure one of the support elements from a deployed, support mode to a storage mode, it may be necessary to de-activate the lock, in addition to thereafter applying a downward force to the one support element to be manually reconfigured (and also possibly rotating, pressuring, or torquing it inwardly and downward) so that all of the support elements of the set will reconfigure to their storage mode. Of course, this specific one support element is, in a preferred embodiment, any of the support elements that a user of the apparatus chooses. The manual manipulation may indeed be one-handed, particularly where the lock is proximate the one support element that is manually forced by, e.g., manually grasping.

In a preferred embodiment, the support elements having the simultaneous deployment capability are each responsive to a sliding collar (23) established around a substantially vertical, central support element (e.g., they may move or rotate or pivot when the collar slides along a central support element), although the point about which they pivot is not the collar in a preferred embodiment. As shown in FIGS. 7 and 8, e.g., the collar may be attached to members that themselves are directly attached to an upper item support element which rotates about an axis.

It should be understood that the inventive apparatus can be made using techniques and knowledge well known to those in the relevant art.

As can be easily understood from the foregoing, the basic concepts of the present invention may be embodied in a variety of ways. It involves both support techniques as well as devices to accomplish the appropriate support. In this application, the support techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this non-provisional application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “support” should be understood to encompass disclosure of the act of “supporting”—whether explicitly discussed or not—and, conversely, were there effectively disclosure of the act of “supporting”, such a disclosure should be understood to encompass disclosure of a “support” and even a “means for supporting” Such changes and alternative terms are to be understood to be explicitly included in the description.

Any acts of law, statutes, regulations, or rules mentioned in this application for patent; or patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the Information Disclosure Statement or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the item support devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, and xii) each potentially dependent claim or concept as a dependency on each and every one of the independent claims or concepts presented.

With regard to claims whether now or later presented for examination, it should be understood that for practical reasons and so as to avoid great expansion of the examination burden, the applicant may at any time present only initial claims or perhaps only initial claims with only initial dependencies. Support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1. A musical instrument support apparatus, comprising:
a first support element; and
at least one second support element that is:
pivotally movable relative to said first support element;
reconfigurable from a deployed, support mode to a retracted mode; and
adapted to contact a musical instrument
wherein said at least one second support element comprises two second support element members that define a first angle when said at least one second support element is in said deployed, support mode and a second angle when said second support element is in said retracted mode,
wherein said second angle is less than said first angle; and
further comprising:
an angle change element that effects a change in the angle defined by said two second support element members between said first angle and second angle when said second support element is moved between said deployed, support mode and said retracted mode; and
a deployed, support mode lock element that locks said at least two support elements in said deployed, support mode.

2. A musical instrument support apparatus as described in claim 1 wherein said deployed, support mode lock element comprises a biasing leaf spring lock.

3. A musical instrument support apparatus as described in claim 1 wherein pivotally movable denotes pivotally movable about a fixed point.

4. A musical instrument support apparatus as described in claim 1 wherein said angle change element comprises a bias element.

5. A musical instrument support apparatus as described in claim 4 wherein angle change element further comprises a guide element.

6. A musical instrument support apparatus as described in claim 4 wherein said bias element comprises a leaf spring.

7. A musical instrument support apparatus as described in claim 4 wherein said bias element comprises at least one coil spring.

8. A musical instrument support apparatus as described in claim 1 wherein said music instrument support apparatus is a guitar support apparatus.

9. A musical instrument support apparatus as described in claim 8 wherein said guitar support apparatus is a multiple guitar support apparatus.

10. A musical instrument support apparatus as described in claim 1 wherein said at least one second support element is at least one upper support element.

11. A musical instrument support apparatus as described in claim 10 wherein said at least one upper support element comprises at least one upper, musical instrument carrier element.

12. A musical instrument support apparatus as described in claim 11 wherein said at least one upper, musical instrument carrier element comprises at least one upper, guitar carrier element.

13. A musical instrument support apparatus as described in claim 11 wherein said at least one upper, musical instrument carrier element comprises at least two upper, musical instrument carrier elements.

14. A musical instrument support apparatus as described in claim 1 further comprising at least one upper support element connected with said first support element.

15. A musical instrument support apparatus as described in claim 14 wherein said at least one upper support element comprises at least one upper, musical instrument carrier element.

16. A musical instrument support apparatus as described in claim 14 wherein said at least one upper support element comprises two upper support elements.

17. A musical instrument support apparatus as described in claim 16 wherein said at least two upper support element comprises three upper support elements.

18. A musical instrument support apparatus as described in claim 17 wherein said at least three upper support element comprises at least four upper support elements.

19. A musical instrument support apparatus as described in claim 14 wherein said at least one upper support element comprises at least two upper support elements.

20. A musical instrument support apparatus as described in claim 19 wherein all of said at least two upper support elements are simultaneously reconfigurable from a retracted mode to a deployed, support mode upon reconfiguration of only one of said at least two upper support elements.

21. A musical instrument support apparatus as described in claim 20 further comprising a second, deployed mode lock element that locks said at least two upper support elements in said deployed, support mode.

22. A musical instrument support apparatus as described in claim 21 wherein said second deployed mode lock element automatically activates when said at least two upper support elements are reconfigured to said deployed, support mode.

23. A musical instrument support apparatus as described in claim 20 wherein said reconfiguration from said retracted mode to said deployed, support mode comprises manual reconfiguration.

24. A musical instrument support apparatus as described in claim 23 wherein said manual reconfiguration comprises one-handed reconfiguration.

25. A musical instrument support apparatus as described in claim 19 wherein said all of said at least two upper support elements are simultaneously reconfigurable from said deployed, support mode to said retracted mode upon reconfiguration of only one of said at least two upper support elements.

26. A musical instrument support apparatus as described in claim 25 wherein said reconfiguration of only one of said at least two upper support elements to reconfigure all of said at least two upper support elements comprises de-activating said second deployed mode lock element and applying a downward force to said only one of said at least two upper support elements.

27. A musical instrument support apparatus as described in claim 26 wherein said reconfiguration of only one of said at least two upper support elements comprises one-handed reconfiguration.

28. A musical instrument support apparatus as described in claim 25 wherein said only one of said at least two upper support elements comprises any one of said upper support elements.

29. A musical instrument support apparatus as described in claim 19 wherein said at least two upper support elements are each pivotally responsive to a sliding collar established around a substantially vertical, central support element.

30. A musical instrument support apparatus as described in claim 14 wherein each of said at least one second support element operates with a corresponding one of said at least one upper support element to support a musical instrument in a desired position.

31. A musical instrument support apparatus as described in claim 30 wherein each said at least one second support element is established at a respective angle in a plane perpendicular to said first support element.

32. A musical instrument support apparatus as described in claim 31 wherein each said at least one upper support element is established above said at least one second support element with which it operates to support a musical instrument, and at the respective angle of said at least one second support element with which it operates to support a musical instrument.

33. A musical instrument support apparatus as described in claim 1 further comprising a base support element connected with said first support element.

34. A musical instrument support apparatus as described in claim 33 wherein said base element is a tripod.

35. A musical instrument support apparatus as described in claim 1 wherein said at least one second support element is at least one musical instrument stop.

36. A musical instrument support apparatus as described in claim 35 wherein said musical instrument stop prevents said musical instrument from contacting said first support element when said at least one second support element is in said deployed, support mode.

37. A musical instrument support apparatus as described in claim 1 wherein said two second support element members do not effect appreciable vertical support of said musical instrument when in said deployed, support mode.

38. A musical instrument support apparatus as described in claim 1 wherein said two second support element members define a V shape having said first angle when said at least one second support element is in said deployed, support mode.

39. A musical instrument support apparatus as described in claim 1 wherein said at least one second support element is established substantially against said first support element when said at least one second support element is in said retracted mode.

40. A musical instrument support apparatus as described in claim 1 wherein each of said two second support element members comprises a pod at an end that is distal of said first support element when said at least one second support element is in said deployed, support configuration.

41. A musical instrument support apparatus as described in claim 1 wherein said at least one second support element folds rotatably downward when said at least one second support element is reconfigured from said deployed, support mode to said retracted mode.

42. A musical instrument support apparatus as described in claim 1 wherein said second angle is greater than said first angle by an amount that is selected from: 10% less, 15% less, 20% less, and 25% less.

43. A musical instrument support apparatus as described in claim 1 wherein said first support element is a substantially vertical, support.

44. A musical instrument support apparatus as described in claim 1 wherein said first support element is vertically adjustable.

45. A musical instrument support method, comprising the steps of:
grasping a musical instrument supported by a collapsible musical instrument support apparatus having a first support element and at least one second support element, each of which itself:
is reconfigurable from a deployed, support mode to a retracted mode, and
comprises two second support element members;
removing said musical instrument from said musical instrument support apparatus while said at least one second support element is in said deployed, support mode;
reconfiguring said at least one second support element from said deployed, support mode to said retracted mode,
reducing an angle defined by said two second support element members while performing said step of reconfiguring.

46. A musical instrument support method as described in claim 45wherein said step of reconfiguring comprises the step of automatically reconfiguring.

47. A musical instrument support method as described in claim 45 wherein said step of reconfiguring comprises the step of pivotally moving.

48. A musical instrument support method as described in claim 45 wherein said step of grasping a musical instrument comprises the step of grasping a guitar.

49. A musical instrument support method as described in claim 45 wherein said step of reconfiguring said at least one second support element comprises the step of reconfiguring at least one lower, musical instrument support element.

50. A musical instrument support method as described in claim 45 further comprising the step of reconfiguring from a deployed, support mode to a retracted mode a base element with which said first support element is connected.

51. A musical instrument support method as described in claim 45 wherein said step of reducing an angle comprises the step of reducing said angle by greater than an amount selected from 10%, 15%, 20%, and 25%.

52. A musical instrument support method as described in claim 45 wherein said step of reconfiguring comprises the step of rotating.

53. A musical instrument support method as described in claim 52 wherein said step of rotating comprises rotating downward.

54. A musical instrument support method as described in claim 45 wherein said at least one second support element comprises at least one upper, musical instrument support element.

55. A musical instrument support method as described in claim 54 wherein said at least one upper, musical instrument support element comprises at least one yoke for supporting a guitar by its headstock.

56. A musical instrument support method as described in claim 54 wherein said at least one upper, musical instrument support element comprises at least two upper support elements.

57. A musical instrument support method as described in claim 45 wherein said at least one second support element comprises at least two second support element.

58. A musical instrument support method as described in claim 57 wherein said step of reconfiguring comprises the step of simultaneously reconfiguring by manipulating only one of said at least two second support elements.

59-104. (canceled)
